(19) United States
(12) Patent Application Publication
(10) Pub. No.: US 2018/0255518 A1
(43) Pub. Date: Sep. 6, 2018

(54) Modulation Specific Measurement Power Offset Reporting in LTE License Assisted Access Systems

(71) Applicant: Telefonaktiebolaget LM Ericsson (publ), Stockholm (SE)

(72) Inventors: SaiRamesh NAMMI, Austin, TX (US); Alireza NEJATIAN, UPPSALA (SE); Imadur RAHMAN, SOLLENTUNA (SE)

(21) Appl. No.: 15/754,391

(22) PCT Filed: Aug. 24, 2016
(86) PCT No.: PCT/SE2016/050791

§ 371 Date: Feb. 22, 2018

Related U.S. Application Data
(60) Provisional application No. 62/209,026, filed on Aug. 24, 2015.

(51) Int. Cl. H04W 52/24; H04W 52/14; H04L 25/02; H04W 52/16; H04W 16/14

(52) U.S. Cl. CPC H04W 52/24; H04W 52/143; H04L 25/0206; H04W 52/267; H04W 16/14; H04W 52/146; H04W 52/16

(57) ABSTRACT

There is disclosed a method for operating a radio node (10, 100) in a wireless communication network. The method comprises determining a power backoff indication based on a modulation. The method further comprises configuring a user equipment (10) and/or a radio node (10, 100) with the power backoff indication, and/or transmitting signals and/or data utilizing the modulation and the power backoff indicated by the power backoff indication.

### TECHNICAL FIELD

The present disclosure pertains to methods and devices for a wireless communication network, in particular in the context of license assisted access (LAA), e.g., for LTE.

### BACKGROUND

The demand for increasing data rates in modern wireless telecommunication systems leads to approaches utilising new frequency ranges. Whereas commonly, wireless (or mobile or cellular) (tele-) communication systems have accessed specific, licensed frequency bands, the use of other frequency bands, which usually are unlicensed, has been proposed. For example, there is some development to access frequency bands usually used by WiFi/WLAN systems. Access to such frequency bands provides new challenges, in particular if combined with operation on licensed bands.

### SUMMARY

The use of unlicensed bands often requires backoff from access, e.g. if a carrier has been found to be busy. If a power backoff is used, this can negatively affect the performance of the system, e.g. due to impacting on channel measurement and/or link adaptation. The present disclosure describes approaches allowing improved use of power backoff ameliorating or avoiding the effect power backoff has on such performance. It should be noted that the approaches are particularly suited for use for accessing and/or in the context of LBT carriers, e.g. in a LAA system.

Accordingly, there is disclosed a method for operating a radio node in a wireless communication network. The method comprises determining a power backoff indication based on a modulation. The method further comprises configuring a user equipment and/or a radio node with the power backoff indication, and/or transmitting signals and/or data utilizing the modulation and the power backoff indicated by the power backoff indication. By determining the power backoff based on the modulation, the signal quality (strength) may be adapted to requirements of the modulation. Hence, sufficient signal transmission quality in particular for high modulation (e.g. 64 QAM or higher) can be facilitated.

Moreover, there is proposed a radio node for a wireless communication network. The radio node is adapted for determining a power backoff indication based on a modulation. The radio node further is adapted for configuring a user equipment and/or a radio node with the power backoff indication and/or is adapted for transmitting signals and/or data utilizing the modulation and the power backoff indicated by the power backoff indication.

A method for operating a radio node in a wireless communication network is considered. The method comprises determining channel state information based on a power backoff indication configured to the radio node. Thus, the channel state information may consider the power backoff indicate, giving a suitable representation of the channel state.

Also, a radio node for a wireless communication network is described. The radio node is adapted for determining channel state information based on a power backoff indication configured to the radio node.

In addition, a program product comprising code executable by control circuitry is proposed. The code causes the control circuitry to carry out and/or control any one of the methods described herein.

There may also be considered a carrier medium arrangement carrying and/or storing a program product as described and/or code executable by control circuitry, the code causing the control circuitry to perform and/or control any one of the methods described herein.

### BRIEF DESCRIPTION OF THE DRAWINGS

The drawings are provided for illustrative purposes, and are not intended to limit the approaches to the embodiments shown. The drawings comprise:

FIG. 1, showing a message sequence chart between eNodeB and UE;

FIG. 2, showing a dependence of ACLR and EVM for 5 GHZ power amplifier for LTE-LAA;

FIG. 3, showing a proposed message sequence chart between eNodeB and UE;

FIG. 4, showing an example of a radio node like a UE;

FIG. 5, showing an example of a radio node like a network node, base station or eNodeB.

### DETAILED DESCRIPTION

LTE-License Assisted Access is described in the following.

3GPP LTE represents the project within the third generation partnership project, with an aim to improve the UMTS standard. 3GPP LTE radio interfaces offer high peak data rates, low delays and high spectral efficiency. The LTE ecosystem supports both Frequency division duplex (FDD) and Time division duplex (TDD) approaches. This enables the operators to exploit both paired and unpaired spectrums, in particular since LTE provides a large flexibility in bandwidth, as it currently supports 6 bandwidths: 1.4 MHz, 3 MHz, 5 MHz, 10 MHz, 15 MHz and 20 MHz.

The LTE physical layer is designed to achieve high data rates, and utilizes turbo coding/decoding, and higher order modulations (up to 64-QAM currently, which are being extended to 256-QAM). The modulation and/or coding is adaptive, and may depend on channel conditions. Orthogonal frequency division multiple access (OFDMA) is used for the downlink, while Single carrier frequency division multiple access (SC-FDMA) is used for the uplink. The main advantage of such schemes is that the channel response is flat over a sub-carrier even though the multi-path environment could be frequency selective over the entire bandwidth. This reduces the complexity involved in equalization, as simple single tap frequency domain equalizers can be used at the receiver. OFDMA allows LTE to achieve its goal of higher data rates, reduced latency and improved capacity/coverage, with reduced costs to the operator. The LTE physical layer supports H-ARQ, power weighting of physical resources, uplink power control, and MIMO (Multiple Input, Multiple Output).

Driven by growing number of LTE subscribers worldwide, the 3GPP started a new activity using unlicensed spectrum with LTE alongside licensed spectrum. This is known as LTE-License Assisted Access (LTE-LAA). This would allow operators to benefit from the additional capacity available from the unlicensed spectrum, particularly in hotspots and corporate environments. With LAA, the extra spectrum resource, especially on the 5 GHz frequency band, can complement licensed band LTE operation.

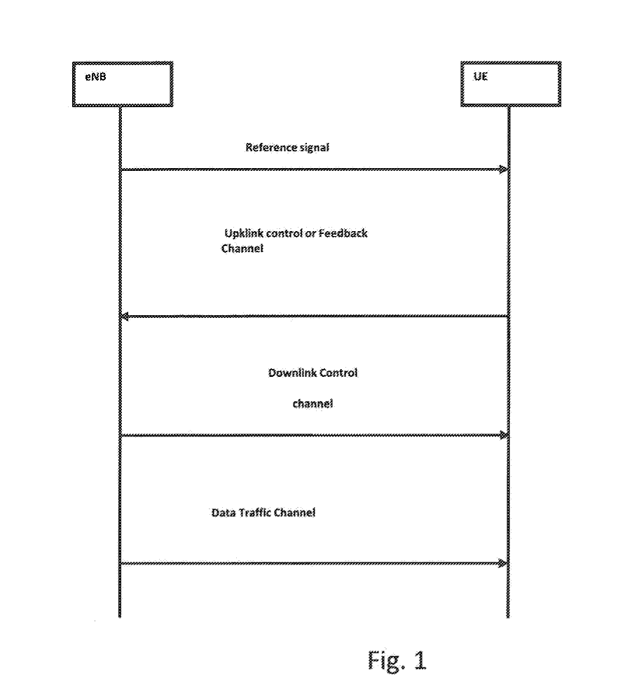

FIG. 1 shows a typical message sequence chart for downlink data transfer in LTE. From the pilot or reference signals (RS, which may be measured by the UE), the UE may determine or compute channel estimates and/or may determine compute parameters needed for channel state information (CSI) reporting, e.g., based on channel estimates or measured pilot or reference signals. CSI information may be provided in or as a report, e.g., a CSI report, which may comprise for example a channel quality indicator (CQI), and/or precoding matrix index (PMI), and/o rank information (RI), and/or indices of preferred or best sub bands, etc.

The UE may send the CSI report sent to a network node like an eNodeB (eNB), e.g., via a feedback channel, which for example may be PUCCH (e.g., for periodic CSI reporting) or PUSCH (e.g., aperiodic CSI reporting). The eNodeB or its scheduler uses information from the report for choosing the parameters for scheduling of the particular UE providing the report. The eNodeB may send scheduling parameters (and/or allocation data and/or configuration data) to the UE, e.g., via a downlink control channel, e.g., PDCCH or ePDCCH (enhanced PDCCH). After this, the actual data transfer (pertaining to user data) may take place from eNodeB to the UE.

An Uplink Control Channel is described in the following.

In LTE, the uplink control channel may carry (and/or, the UE may send via this channel) information about HARQ-ACK (acknowledging complete reception of a data block or indicating non-acknowledgement) corresponding to the downlink data transmission, and/or channel state information. The channel state information typically consists of RI, CQI, and PMI. Either PUCCH or PUSCH can be used to carry this information. Note that the PUCCH reporting may be periodic and the periodicity of the PUCCH may be configured by the higher layers, while the PUSCH reporting may be aperiodic. Also note that there are various modes for PUCCH and PUSCH and in general it depends on the transmission mode and the formats is configured via higher layer signaling.

A transmission mode may generally pertain to a mode of transmission of signals, e.g., defined by transmission power and/or carrier/s and/or modulation and/or coding used.

A Downlink Control Channel (DCI) is described in the following.

In LTE, the downlink control channel (PDCCH) carries information about the scheduling grants (e.g., allocation data and/or configuration data) Typically, this may comprise information indicating e.g., a number of MIMO layers scheduled, and/or indicating transport block sizes (size of data blocks, in particular data blocks belonging to one HARQ process), and/or indicating modulation (e.g., for each codeword), and/or indicating parameters related to HARQ, and/or indicating sub band resources and/or locations and/or indicating PMI corresponding to (such) sub bands.

PDSCH—Power Allocation and CSI Reporting Procedures

For configuring a UE for or with transmission power parameters, the eNodeB may determine a downlink transmit energy per resource element (a resource element in LTE may be considered the smallest time-frequency resource, which may comprise 1 subcarrier and 1 associated symbol). The UE receives or gets the parameters related to CQI reporting, and PDSCH configuration using RRC signaling (see, e.g. TS 36.331). The information element (IE) PDSCH-ConfigCommon and the IE PDSCH-ConfigDedicated specifies the common and the UE specific PDSCH configuration respectively. The PDSCH common parameters referenceSignalPower, P_{B} are common to the all the UEs (served by the eNodeB and/or in the cell); dedicated parameters such as P_{A} (transmitting power (to the UE), in particular for REs in which no reference signaling is scheduled/performed) may be configured differently for each individual UE. The referenceSignalPower is defined as the linear average over the power contributions (in [W]) of all resource elements that carry cell-specific reference signals within the operating system bandwidth. The ratio of PDSCH Energy Per Resource Element (EPRE) to cell-specific RS EPRE among PDSCH REs for each OFDM symbol is denoted by either ρ_{A} or ρ_{B} according to the OFDM symbol index [TS 36.213].

In an example, it may be assumed that the power of the reference signal is set to −50 dBm and P_{A}=−4.77 dB and P_{B}=−3.98 dB. Then, for CSI reporting the UE should assume power ρ_{A}=P_{A}+Δ_{offset} [dB] for PDSCH power on the resource elements where RS is not present and power which depends on P_{B} and P_{A} (Table 5.2.1 of TS 36.213) for those resource elements where RS is present. Note that Δ_{offset} is an offset parameter which is configured by higher-layer signalling which is independent of modulation, and typically is 0 dB.

Power back off in LTE-LAA transmitters is described in the following.

To reduce the complexity of LAA base stations, it was proposed to relax the adjacent channel leakage ratio (ACLR) requirement of the current 3GPP LTE standard which is −45 dBc to −30 dBc as the LTE-LAA base stations transmit with low power, e.g.30 dBm or 24 dBm or 18 dBm. However, relaxing the ACLR requirement has side impacts such as increased error vector magnitude (EVM, a measure of internal deviations of transmitting circuitry).

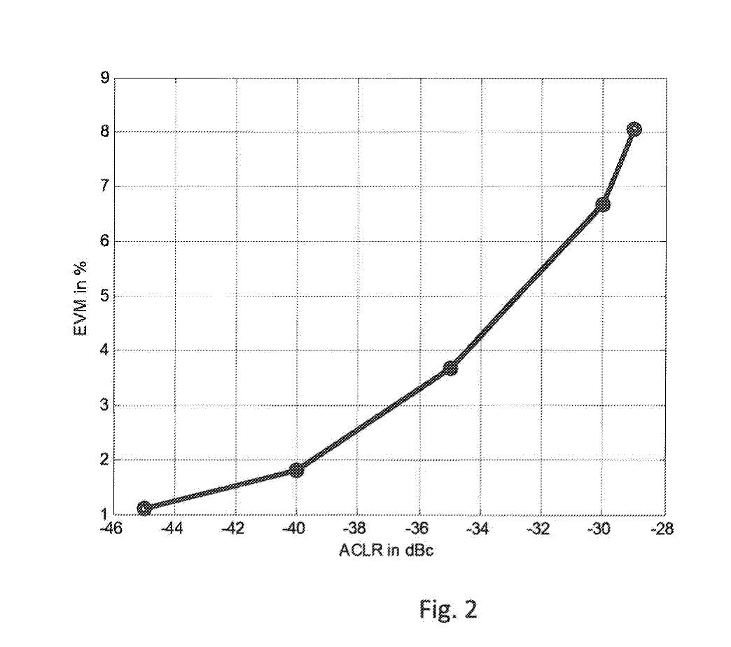

FIG. 2 shows an example of how the ACLR and EVM are related using a practical 5 GHz power amplifier (PA). It can be observed that when the ACLR is increased, the EVM decreases.

This is because relaxing the ACLR e.g., to -30 dBc implies that the signal at the output of the transmitter is non-linear. This increases the receiver EVM, hence the minimum EVM requirement set by 3GPP may not be met. Table 1 shows the minimum EVM requirement set by the 3GPP for various modulation schemes for the LTE base station.

TABLE 1
EVM requirement of current 3GPP standard

| Modulation | % EVM |
|---|---|
| QPSK | 17.5 |
| 16-QAM | 12.5 |
| 64-QAM | 8 |
| 256-QAM | 3.5 |

It can be observed from FIG. 2 and Table 1 that, if the ACLR is relaxed for example to −30 dBc, use of 256-QAM and 64-QAM by the base station may be limited, at least to some extent, as is may not be possible to meet the EVM requirement of 3.5% and 8% in LAA (in particular using 5 GHz PA). In other words, the base station (network node/eNodeB) may not be able to schedule the UE with transport format or MCS involving 256-QAM or 64-QAM.

One solution to solve this problem is to do power back off such that the PA operates in the linear region.

Reducing the transmit power dynamically (performing power backoff, which may refer to reducing the power/total power transmitted in a given time interval), e.g., by 6 dB or 3 dB may have negative implications on the system behavior or throughput. A first implication may comprise reduction of coverage. A second implication may comprise link adaptation errors caused by power backoff. This is because in LTE, the eNodeB needs to send the reference signal power (as an absolute value, representing the power used and/or intended for (regular) reference signals), power related to resource elements (relative to the reference signal) during the cell setup (RRC setup) and the UE uses these parameters for computing the channel state information (CQI and/or CSI, PMI, RI etc.) and also to decode the PDSCH.

When utilizing power backoff, the power of the reference signal (respectively, the relative power values) may be different before power back off and after power back off, which may lead to a mismatch between these values, which in turn may cause link adaptation errors. Hence, throughput may be reduced.

One way to solve this problem is to send a RRC reconfiguration message with updated parameters once the back off is completed. However, a RRC re-configuration message is a higher layer signaling message (higher than the physical/radio layers) and incurs undesired delay.

Moreover, frequent RRC re-configuration consumes data resources, thereby reducing the system throughput.

In this disclosure, there are proposed methods and devices aimed at providing improved behavior for such power backoff, e.g., facilitating a low complexity adaptive wireless communication system without impacting the coverage while at the same time avoiding the throughput loss due to link adaptation mismatches (link adaption errors).

The methods outlined may:
Facilitate a low cost implementation of LAA products without significantly reducing the user throughput, while at the same time meeting the current 3GPP EVM requirements, and/or
Have limited or no impact on the coverage as the power of the reference signals is kept constant irrespective of the power back off values
Avoids link adaptation errors, hence there is no major impact to the throughput.

Note that terminology such as base station, NodeB or eNode B and UE should be considering non-limiting and does in particular not imply a certain hierarchical relation between the two; in general, “NodeB” could be considered as device 1 and “UE” device 2, and these two devices communicate with each other over some radio channel. A generic term network node is used in some embodiments. The network node can be a base station, access point, NodeB or eNode B, etc. A generic term wireless device is used in some embodiments.

The wireless device can be any type of UE such as D2D UE, MTC UE, etc. Yet another generic term, radio node, may be used in some embodiments. The radio node may be a network node or a wireless device. In some embodiment several radio nodes may be used e.g., first radio node, second radio node, third radio node etc. The first radio node transmits signals to the second radio node. For example, the first and the second radio nodes can be a base station and UE, respectively, or vice versa. The third radio node may be neighboring to, or connected to, the second radio node.

Herein, it is focused on wireless transmissions in the downlink, but the approaches may be applied in the uplink (and/or pertain to transmission in any direction).

As mentioned herein, to support 256-QAM and 64-QAM for UEs, the transmitting power and/or the power of the power amplifier may need a power backoff (power reduction).

Generally, there is suggested a method for operating a network node (which may be a transmitting node and/or radio node and/or eNodeB). The method may comprise determining a power backoff indication based on a modulation. It may be considered that the method comprises configuring a user equipment and/or a radio node with the power backoff indication. The method may comprise transmitting signals and/or data utilizing the modulation and the power backoff indicated by the power backoff indication.

There may be considered a network node (and/or radio node and/or eNodeB). The node may be adapted for, and/or comprise a determining module for, determining a power backoff indication based on a modulation. The node may be adapted for, and/or comprise a configuring module for, configuring a user equipment and/or a radio node with the power backoff indication. Optionally, the node may be adapted for, and/or comprise a transmitting module for, transmitting signals and/or data utilizing the modulation and the power backoff indicated by the power backoff indication.

Alternatively or additionally, a method for operating a radio node (which may be a receiving node and/or, e.g., a user equipment or terminal) is described. The method may comprise determining channel state information based on a power backoff indication configured to the radio node (e.g., by a network node), wherein the power backoff indication may be based on a modulation to be used for non-reference signaling to be received (which may generally be transmitted by and/or received from the network node, e.g., the network node configuring the radio node). It may be considered that the method comprises determining channel state information based on the power backoff indication, and/or detecting and/or decoding signals (in particular transmitted non-reference signaling) based on the power backoff indication.

A radio node (which may be a receiving node and/or, e.g., a user equipment or terminal) is also described. The radio node may be adapted for, and/or comprise a determining module for, determining channel state information based on a power backoff indication configured to the radio node (e.g., by a network node), wherein the power backoff indication may be based on a modulation to be used for non- reference signaling to be received (which may generally be transmitted by and/or received from the network node, e.g., the network node configuring the radio node). It may be considered that the node is adapted for, and/or comprise a channel state information module for, determining channel state information based on the power backoff indication, and/or is adapted for, and/or comprises a decoding module for, detecting and/or decoding signals (in particular transmitted non-reference signaling) based on the power backoff indication.

Determining channel state information may comprise computing parameter/s indicative of a channel state, e.g., ρ_{A} and/or according to equation 1 and/or determining and/or computing CSI and/or CQI. It may be considered that determining channel state information may comprise performing measurements pertaining to, and/or on, at least one channel and/or carrier and/or at least one cell, in particular of a carrier aggregate as described herein. The measurements may in particular pertain to non-reference signaling.

The power backoff indication may be considered as and/or to represent or indicate a modulation-dependent backoff or offset. A power backoff indication may be based on operational and/or regulatory requirements, e.g., based on EVM and/or ACLR.

Transmitting signals and/or data utilizing the modulation and the power backoff indicated by the power backoff indication may comprise setting the modulation and the power used for transmission accordingly. The signals (non-reference signaling) may be in REs not used for reference signaling and/or may comprise and/or consist of signals or symbols which are not reference signals or symbols. The power backoff may in particular pertain to non-reference signaling, and/or reduce the transmitting power for non-reference signaling based on the modulation used.

It may be considered that transmitting is performed in, and/or the radio node (e.g., network node or UE) is adapted for, carrier aggregation and/or a carrier aggregate, in particular in the context of LAA and/or comprising at least one primary carrier (e.g., DL) and at least one LBT carrier and/or unlicensed carrier (e.g., DL).

Configuring may be based on and/or utilize higher-layer signaling, in particular of a layer above the physical/radio layer/s, e.g., RRC signaling.

The power backoff indication may generally comprise and/or indicate an offset, e.g., a measurement offset. Determining based on a modulation may be performed as described herein and/or pertain to specific modulations (e.g., 256-QAM, 64-QAM) having associated to them specific power backoffs (and corresponding indications being used). A power backoff indication may generally indicate (e.g., directly or indirectly) the power backoff. Some modulations may have associated to them the same power backoff, e.g., 0 dB (e.g., for lower order modulations, e.g., 32-QAM and/or lower orders). It may be considered that a table is provided (e.g., stored in memory of a radio node), mapping power backoff indications to associated power backoffs and/or modulations. The power backoff/measurement offset may be 6 dB for 256-QAM and/or 3 dB for 64-QAM.

The radio node or network node (in particular eNodeB or base station) may be adapted for and/or perform carrier aggregation, e.g., pertaining to a carrier aggregate, e.g., in the context of LAA (in which at least one carrier of the aggregate may be a (in particular, DL) carrier for which LBT is performed for access and/or is an unlicensed carrier). Performing carrier aggregation may comprise controlling and/or providing the carrier aggregate, e.g., to one or more receiving node/s (e.g., radio node, like user equipment and/or terminal). Controlling may comprise configuring the node/s the aggregate is provided to for carrier aggregation.

A radio node like a user equipment or terminal or receiving node may be configured for carrier aggregation, e.g., by a transmitting node or network node.

Detecting and/or decoding a signal/s may comprise demodulating the signal/s.

For example, it is proposed that the network (e.g., network node/radio node) first identifies or determines the power back off parameter/s and/or factor/s (in particular an indication of the power backoff, e.g., an offset), in particular based on a modulation. The parameter/s and/or factor/s may be indicated and/or communicated and/or configured to a UE, e.g., using RRC signaling. The offset may be referred to as D_meas, for example. This offset may be considered a power backoff indication

Note that D_meas is defined for each modulation/modulation type and that different modulation may have associated to them different D_meas values. The power back off parameter/s or indication may be determined or chosen such that the eNB can support the 3GPP requirements for EVM or for satisfactory operations for each modulation scheme. For example, 3 dB power back off for 64 QAM, 6 dB power back off for 256-QAM and 0 dB power back off for QPSK and 16-QAM.

Once the UE receives the measurement parameters and power parameters, it may compute parameters for CSI and/or CQI, e.g.,

ρ_{A}=P_{A}+D_meas+Δ_{offset} (equation 1)

The UE may use these values in computing the CSI and also during PDCCH/PDSCH detection and demodulation.

ρ_{A} may describe the ratio of PDSCH EPRE (Energy Per Resource Element) to cell- specific RS EPRE among PDSCH REs (not applicable to PDSCH REs with zero EPRE) for each OFDM symbol.

Δ_{offset} may be the measurement offset to take care of impairments in the Tx chain which is common for all modulation schemes

P_{A} is the power set by the eNode B in those RE s which does not transmit RS

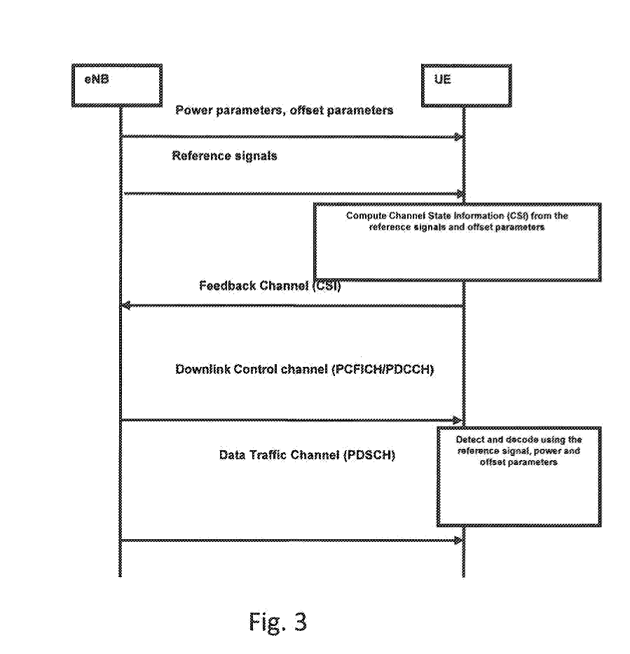

FIG. 3 shows an exemplary message sequence chart of the proposed technique. As shown in FIG. 3, the eNode B communicates the measurement offset parameter/s (representing a power backoff indication) based on modulation. The UE uses these parameters in determining/computing the CSI and detection and decoding of PDCCH/PDSCH.

There may be considered a method for operating a, and/or in, a transmission node for performing power backoff based on modulation and configuring and/or communicating these values and/or an indication of power backoff performed to a UE, e.g., using higher layer signaling, e.g., RRC.

Alternatively or additionally, there may be considered a method for operating a and/or in a receiving node, the method comprising receiving modulation dependent measurement offset values and using these values in computing CSI and/or decoding the PDCCH/PDSCH.

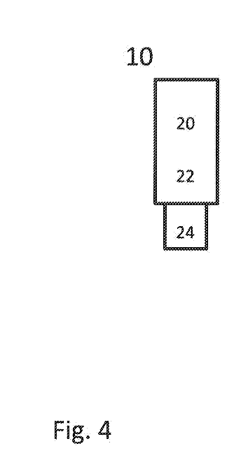

FIG. 4 schematically shows a user equipment 10 as an example of a radio node. User equipment 10 comprises control circuitry 20, which may comprise a controller connected to a memory. Any module of a user equipment may be implemented in and/or executable by, user equipment, in particular the control circuitry 20. User equipment 10 also comprises radio circuitry 22 providing receiving and transmitting or transceiving functionality, the radio circuitry 22 connected or connectable to the control circuitry. An antenna circuitry 24 of the user equipment 10 is connected or connectable to the radio circuitry 22 to collect or send and/or amplify signals. Radio circuitry 22 and the control circuitry 20 controlling it are configured for cellular communication and/or D2D communication, in particular utilizing E-UTRAN/LTE resources as described herein. The user equipment 10 may be adapted to carry out any of the methods for operating a radio node or terminal disclosed herein; in particular, it may comprise corresponding circuitry, e.g., control circuitry. Transmitting by such a radio node may comprise transmitting one or more UL carriers.

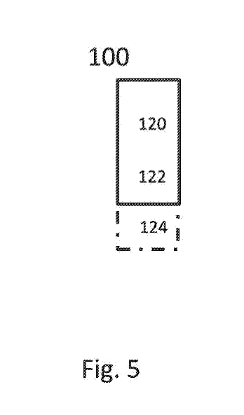

FIG. 5 schematically show a network node or base station 100 as an example of a radio node, which in particular may be an eNodeB. Network node 100 comprises control circuitry 120, which may comprise a controller connected to a memory. Any module of a network node, e.g., a receiving module and/or transmitting module and/or control or processing module and/or scheduling module, may be implemented in and/or executable by the network node, in particular the control circuitry 120. The control circuitry 120 is connected to control radio circuitry 122 of the network node 100, which provides receiver and transmitter and/or transceiver functionality. An antenna circuitry 124 may be connected or connectable to radio circuitry 122 for signal reception or transmittance and/or amplification. The network node 100 may be adapted to carry out any of the methods for operating a radio node disclosed herein; in particular, it may comprise corresponding circuitry, e.g., control circuitry. Transmitting by such a radio node may comprise transmitting one or more DL carriers.

There may be generally considered a network node adapted for performing any one of the methods for operating a radio node (e.g., transmitting node or network node or base station or eNodeB) described herein.

There may be considered a radio node (e.g., receiving node and/or user equipment and/or terminal) adapted for performing any one of the methods for operating a radio node like receiving node or a user equipment or terminal described herein.

There is also disclosed a program product comprising code executable by control circuitry, the code causing the control circuitry to carry out and/or control any one of the method for operating a user equipment or network node as described herein, in particular if executed on control circuitry, which may be control circuitry of a radio node like a user equipment or a network node as described herein.

Moreover, there is disclosed a carrier medium arrangement carrying and/or storing at least any one of the program products described herein and/or code executable by control circuitry, the code causing the control circuitry to perform and/or control at least any one of the methods described herein. A carrier medium arrangement may comprise one or more carrier media. Generally, a carrier medium may be accessible and/or readable and/or receivable by control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g., radio waves or microwaves, and/or optically transmissive material, e.g., glass fiber, and/or cable. A storage medium may comprise at least one of a memory, which may be volatile or non-volatile, a buffer, a cache, an optical disc, magnetic memory, flash memory, etc.

In the context of this specification, a wireless communication network may comprise one or more (radio) nodes or devices adapted for wireless and/or radio communication, in particular according to a pre-determined standard like LTE. It may be considered that one or more radio nodes are connected or connectable to a core network and/or other network nodes of the network, e.g., for transmission of data and/or control. A wireless communication system may comprise at least one radio node (which may be a base station or eNodeB), which may be connected or connectable to a core network, and/or may comprise and/or provide control functionality and/or at least one corresponding control node, e.g., for mobility management and/or data packet transmission and/or charging-related functionality.

A radio node may generally be any device adapted for transmitting and/or receiving radio and/or wireless signals and/or data, in particular communication data, in particular on at least one carrier. The at least one carrier may comprise a carrier accessed based on a LBT procedure (which may be called LBT carrier), e.g., an unlicensed carrier. It may be considered that the carrier is part of a carrier aggregate. A carrier aggregate may generally comprise a plurality of carriers, wherein one carrier may be a primary carrier and/or other carriers may be secondary carriers. It may be considered that carriers of a carrier aggregate are synchronized according to a pre-defined time structure and/or in relation to a synchronizing carrier, which may be a primary carrier. A primary carrier may be a carrier on which control information and/or scheduling data is transmitted and/or which carries one or more control channels for the carrier aggregate and/or one or more carriers. A carrier aggregate may comprise UL carrier/s and/or DL carrier/s. A carrier aggregate may comprise one or more LBT carriers. It may be considered that a carrier aggregate additionally comprises one or more carriers for which no LBT procedure for access is performed, e.g., licensed carriers. A primary carried may be such a carrier, in particular a licensed carrier. Accordingly, in some variants a carrier for which LBT is performed may be in a carrier aggregate comprising at least one carrier for which no LBT is performed, in particular a licensed carrier. A licensed carrier may generally be a carrier licensed for a specific Radio Access Technology (RAT), e.g., LTE. A radio node may in particular be a user equipment or a base station and/or relay node and/or micro-(or pico/femto/nano-) node of or for a network, e.g., an eNodeB. Transmission of data may be in uplink (UL) for transmissions from a user equipment to a base station/node/network. Transmission of data may be considered in downlink (DL) for transmission from a base station/node/network to a user equipment. The target of transmission may generally be another radio node, in particular a radio node as described herein.

Communication data may be data intended for transmission. It may be considered that communication data comprises, and/or is of, one or more types of data. One type of data may be control data, which in particular may pertain to scheduling and/or measurements and/or configuring of radio nodes. Another type of data may be user data. Communication data may be data to be transmitted, which may be stored in a data buffer of the radio node for transmission.

The LBT procedure may comprise a number of Clear Channel Assessments or CCA procedures, wherein the number may be larger than one and/or be based on a random backoff number or counter.

A radio node may generally be a network node or a terminal and/or user equipment.

A LBT procedure may comprise one or more Clear Channel Assessment (CCA, may also be called Clear Carrier Assessment) procedures. A CCA procedure may generally comprise sensing and/or determining the energy and/or power received on or for the channel or carrier (by the radio node performing the CCA procedure) the LBT procedure is performed on and/or pertains to, in particular over a time interval or duration, which may be called the CCA interval or duration. Generally, different CCA procedures may have different CCA intervals or durations, e.g., according to a configuration. The number of CCA procedures to be performed for a LBT procedure may be dependent on a backoff counter, which may be random and/or be based on one or more parameters as described herein. A CCA may indicate that a carrier or channel is idle if the power and/or energy sensed or determined is below a threshold, which may be a pre-determine threshold and/or be determined by the radio node, e.g., based on operating conditions and/or a configuration; if it is above or reaching the threshold, the carrier or channel may be indicated to be busy. A LBT procedure may be considered to determine that access to a carrier is allowed based on a number (e.g., a pre-determined number, e.g., according to a backoff counter) of CCAs performed indicating that the carrier or channel is idle. In some cases, the number may indicate a number of consecutive indications of the carrier being idle. It may be generally considered that the radio node is adapted for such sensing and/or determining and/or for carrying out CCA, e.g., by comprising suitable sensor equipment and/or circuitry and/or a corresponding sensing module. Such a sensing module may be part of and/or be implemented as or in a LBT module. Performing a LBT procedure to determine whether accessing a carrier or channel is allowed may include performing one or more CCA procedures on that carrier or channel.

Generally, control circuitry may comprise integrated circuitry for processing and/or control, e.g., one or more processors and/or processor cores and/or FPGAs (Field Programmable Gate Array) and/or ASICs (Application Specific Integrated Circuitry). Control circuitry may comprise and/or be connected to and/or be adapted for accessing (e.g., writing to and/or reading from) memory, which may comprise any kind of volatile and/or non-volatile memory, e.g., cache and/or buffer memory and/or RAM (Random Access Memory) and/or ROM (Read-Only Memory) and/or optical memory and/or EPROM (Erasable Programmable Read-Only Memory). Such memory may be adapted to store code executable by control circuitry and/or other data, e.g., data pertaining to communication, e.g., configuration/s and/or address data of nodes, etc. Control circuitry may be adapted to control any of the methods described herein and/or to cause such methods to be performed, e.g., by the radio node. Corresponding instructions may be stored in the memory, which may be readable and/or readably connected to the control circuitry. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry.

Radio circuitry may comprise receiving circuitry (e.g., one or more receivers) and/or transmitting circuitry (e.g., one or more transmitters). Alternatively or additionally, radio circuitry may comprise transceiving circuitry for transmitting and receiving (e.g., one or more transceivers). It may be considered that radio circuitry comprises a sensing arrangement for performing LBT/CCA.

Radio circuitry may generally comprise, for example, a receiver device and/or transmitter device and/or transceiver device.

Antenna circuitry may comprise one or more antennas or antenna elements, which may be arranged in an antenna array. It may be considered that antenna circuitry comprises one or more additional elements and/or is connected or connectable to one or more additional elements, e.g., wiring and/or

Configuring a radio node, in particular a user equipment, may refer to the radio node being adapted or caused or set to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g., regarding a freeze interval and/or a transmission start interval. A radio node may configure itself, e.g., based on configuration data received from a network or network node.

Generally, configuring may include determining configuration data representing the configuration and providing it to one or more other nodes (parallel and/or sequentially), which may transmit it further to the radio node (or another node, which may be repeated until it reaches the wireless device). Alternatively or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE.

A carrier may comprise a continuous or discontinuous radio frequency bandwidth and/or frequency distribution, and/or may carry, and/or be utilized or utilizable for transmitting, information and/or signals, in particular communication data. It may be considered that a carrier is defined by and/or referred to and/or indexed according to for example a standard like LTE. A carrier may comprise one or more subcarriers. A set of subcarriers (comprising at least one subcarrier) may be referred to as carrier, e.g., if a common LBT procedure (e.g., measuring the total energy/power for the set) is performed for the set. A channel may comprise at least one carrier. A channel may in particular be a physical channel and/or comprise and/or refer to a frequency range. Accessing a carrier or channel may comprise transmitting on the carrier. If accessing a carrier or channel is allowed, this may indicate that transmission on this carrier is allowed.

A storage medium may generally be computer-readable and/or accessible and/or readable by control circuitry (e.g., after connecting it to a suitable device or interface), and may comprise, e.g., an optical disc and/or magnetic memory and/or a volatile or non-volatile memory and/or flash memory and/or RAM and/or ROM and/or EPROM and/or EEPROM and/or buffer memory and/or cache memory and/or a database and/or an electrical or optical signal.

The terms “interval” and “period” may be used interchangeably throughout this disclosure.

A LAA node may be a radio node adapted for LAA.

In the context of this description, wireless communication may be communication, in particular transmission and/or reception of data, via electromagnetic waves and/or an air interface, in particular radio waves, e.g., in a wireless communication network and/or utilizing a radio access technology (RAT). The communication may involve one or more than one terminals connected to a wireless communication network and/or more than one node of a wireless communication network and/or in a wireless communication network. It may be envisioned that a node in or for communication, and/or in, of or for a wireless communication network is adapted for communication utilizing one or more RATs, in particular LTE/E-UTRA. A communication may generally involve transmitting and/or receiving messages, in particular in the form of packet data. A message or packet may comprise control and/or configuration data and/or payload data and/or represent and/or comprise a batch of physical layer transmissions. Control and/or configuration data may refer to data pertaining to the process of communication and/or nodes and/or terminals of the communication. It may, e.g., include address data referring to a node or terminal of the communication and/or data pertaining to the transmission mode and/or spectral configuration and/or frequency and/or coding and/or timing and/or bandwidth as data pertaining to the process of communication or transmission, e.g., in a header. Each node or terminal involved in communication may comprise radio circuitry and/or control circuitry and/or antenna circuitry, which may be arranged to utilize and/or implement one or more than one radio access technologies. Radio circuitry of a node or terminal may generally be adapted for the transmission and/or reception of radio waves, and in particular may comprise a corresponding transmitter and/or receiver and/or transceiver, which may be connected or connectable to antenna circuitry and/or control circuitry. Control circuitry of a node or terminal may comprise a controller and/or memory arranged to be accessible for the controller for read and/or write access. The controller may be arranged to control the communication and/or the radio circuitry and/or provide additional services. Circuitry of a node or terminal, in particular control circuitry, e.g., a controller, may be programmed to provide the functionality described herein. A corresponding program code may be stored in an associated memory and/or storage medium and/or be hardwired and/or provided as firmware and/or software and/or in hardware. A controller may generally comprise a processor and/or microprocessor and/or microcontroller and/or FPGA (Field- Programmable Gate Array) device and/or ASIC (Application Specific Integrated Circuit) device. More specifically, it may be considered that control circuitry comprises and/or may be connected or connectable to memory, which may be adapted to be accessible for reading and/or writing by the controller and/or control circuitry. Radio access technology may generally comprise, e.g., Bluetooth and/or Wifi and/or WIMAX and/or cdma2000 and/or GERAN and/or UTRAN and/or in particular E-Utran and/or LTE. A communication may in particular comprise a physical layer (PHY) transmission and/or reception, onto which logical channels and/or logical transmission and/or receptions may be imprinted or layered.

A node of a wireless communication network may be implemented as a radio node, in particular a terminal and/or user equipment or base station and/or relay node and/or any device generally adapted for communication in a wireless communication network, in particular cellular communication.

A cellular or wireless communication network may comprise a network node, in particular a radio network node or radio node. A network node may be connected or connectable to a core network, e.g., a core network with an evolved network core, e.g., according to LTE. A network node may, e.g., be a base station or eNodeB. The connection between the network node and the core network/network core may be at least partly based on a cable/landline connection. Operation and/or communication and/or exchange of signals involving part of the core network, in particular layers above a base station or eNB, and/or via a predefined cell structure provided by a base station or eNB, may be considered to be of cellular nature or be called cellular operation. Operation and/or communication and/or exchange of signals without involvement of layers above a base station and/or without utilizing a predefined cell structure provided by a base station or eNB, may be considered to be D2D communication or operation, in particular, if it utilizes the radio resources, in particular carriers and/or frequencies, and/or equipment (e.g., circuitry like radio circuitry and/or antenna circuitry, in particular transmitter and/or receiver and/or transceiver) provided and/or used for cellular operation.

A radio node like a terminal may be implemented as a mobile terminal and/or user equipment. A terminal or a user equipment (UE) may generally be a device configured for wireless device-to-device communication and/or a terminal for a wireless and/or cellular network, in particular a mobile terminal, for example a mobile phone, smart phone, tablet, PDA, etc. A user equipment or terminal may be a node of or for a wireless communication network as described herein, e.g., if it takes over some control and/or relay functionality for another terminal or node. It may be envisioned that terminal or a user equipment is adapted for one or more RATs, in particular LTE/E-UTRA. A terminal or user equipment may generally be proximity services (ProSe) enabled, which may mean it is D2D capable or enabled. It may be considered that a terminal or user equipment comprises radio circuitry and/control circuitry for wireless communication. Radio circuitry may comprise for example a receiver device and/or transmitter device and/or transceiver device. Control circuitry may include a controller, which may comprise a microprocessor and/or microcontroller and/or FPGA (Field-Programmable Gate Array) device and/or ASIC (Application Specific Integrated Circuit) device. It may be considered that control circuitry comprises or may be connected or connectable to memory, which may be adapted to be accessible for reading and/or writing by the controller and/or control circuitry. It may be considered that a terminal or user equipment is configured to be a terminal or user equipment adapted for LTE/E-UTRAN. Generally, a terminal may be adapted for MTC (machine-type communication). Such a terminal may be implemented as or associated to a sensor/sensor arrangement and/or smart device and/or lighting/lighting arrangement and/or remotely controlled and/or monitored device (e.g., smart-meter).

A network node may be a base station, which may be any kind of base station of a wireless and/or cellular network adapted to serve one or more terminals or user equipments. It may be considered that a base station is a node or network node of a wireless communication network. A network node or base station may be adapted to provide and/or define and/or to serve one or more cells of the network and/or to allocate frequency and/or time resources for communication to one or more nodes or terminals of a network. Generally, any node adapted to provide such functionality may be considered a base station. It may be considered that a base station or more generally a network node, in particular a radio network node, comprises radio circuitry and/or control circuitry for wireless communication. It may be envisioned that a base station or network node is adapted for one or more RATs, in particular LTE/E- UTRA.

A base station may be arranged to be a node of a wireless communication network, in particular configured for and/or to enable and/or to facilitate and/or to participate in cellular communication, e.g., as a device directly involved or as an auxiliary and/or coordinating node. Generally, a base station may be arranged to communicate with a core network and/or to provide services and/or control to one or more user equipments and/or to relay and/or transport communications and/or data between one or more user equipments and a core network and/or another base station and/or be Proximity Service enabled. An eNodeB (eNB) may be envisioned as an example of a base station, e.g., according to an LTE standard. A base station may generally be proximity service enabled and/or to provide corresponding services. It may be considered that a base station is configured as or connected or connectable to an Evolved Packet Core (EPC) and/or to provide and/or connect to corresponding functionality. The functionality and/or multiple different functions of a base station may be distributed over one or more different devices and/or physical locations and/or nodes. A base station may be considered to be a node of a wireless communication network. Generally, a base station may be considered to be configured to be a coordinating node and/or to allocate resources in particular for cellular communication between two nodes or terminals of a wireless communication network, in particular two user equipments.

It may be considered for cellular communication there is provided at least one uplink (UL) connection and/or channel and/or carrier and at least one downlink (DL) connection and/or channel and/or carrier, e.g., via and/or defining a cell, which may be provided by a network node, in particular a base station or eNodeB. An uplink direction may refer to a data transfer direction from a terminal to a network node, e.g., base station and/or relay station. A downlink direction may refer to a data transfer direction from a network node, e.g., base station and/or relay node, to a terminal. UL and DL may be associated to different frequency resources, e.g., carriers and/or spectral bands. A cell may comprise at least one uplink carrier and at least one downlink carrier, which may have different frequency bands. A network node, e.g., a base station or eNodeB, may be adapted to provide and/or define and/or control one or more cells, e.g., a PCell and/or a LA cell.

A network node, in particular a base station, and/or a terminal, in particular a UE, may be adapted for communication in spectral bands (frequency bands) licensed and/or defined for LTE. In addition, a network node, in particular a base station/eNB, and/or a terminal, in particular a UE, may be adapted for communication in freely available and/or unlicensed/LTE-unlicensed spectral bands (frequency bands), e.g., around 5 GHz.

Configuring a terminal or wireless device or node may involve instructing and/or causing the wireless device or node to change its configuration, e.g., at least one setting and/or register entry and/or operational mode. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., allocation data (which may also be and/or comprise configuration data) and/or scheduling data and/or scheduling grants. Configuring a terminal may include sending allocation/configuration data to the terminal indicating which modulation and/or encoding to use. A terminal may be configured with and/or for scheduling data and/or to use, e.g., for transmission, scheduled and/or allocated uplink resources, and/or, e.g., for reception, scheduled and/or allocated downlink resources. Uplink resources and/or downlink resources may be scheduled and/or provided with allocation or configuration data.

A modulation of and/or modulating HARQ/ACK information/feedback may include an encoding and/or performing encoding. Allocation data configuring or indicating a modulation may include an indication which encoding to use for HARQ/ACK information/feedback. The term modulation may be used to refer to data (e.g., allocation data) representing and/or indicating the modulation used and/or to be used by a terminal.

A wireless communication network may comprise a radio access network (RAN), which may be adapted to perform according to one or more standards, in particular LTE, and/or radio access technologies (RAT).

A network device or node and/or a wireless device may be or comprise a software/program arrangement arranged to be executable by a hardware device, e.g., control circuitry, and/or storable in a memory, which may provide the described functionality and/or corresponding control functionality.

A cellular network or mobile or wireless communication network may comprise e.g., an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g., LTE FDD, LTE TDD, GSM, CDMA, WCDMA, WiFi, WLAN, WiMAX, etc.

A storage medium may be adapted to store data and/or store instructions executable by control circuitry and/or a computing device, the instruction causing the control circuitry and/or computing device to carry out and/or control any one of the methods described herein when executed by the control circuitry and/or computing device. A storage medium may generally be computer-readable, e.g., an optical disc and/or magnetic memory and/or a volatile or non-volatile memory and/or flash memory and/or RAM and/or ROM and/or EPROM and/or EEPROM and/or buffer memory and/or cache memory and/or a database.

Resources or communication resources or radio resources may generally be frequency and/or time resources (which may be called time/frequency resources). Allocated or scheduled resources may comprise and/or refer to frequency-related information, in particular regarding one or more carriers and/or bandwidth and/or subcarriers and/or time-related information, in particular regarding frames and/or slots and/or subframes, and/or regarding resource blocks and/or time/frequency hopping information. Allocated resources may in particular refer to UL resources, e.g., UL resources for a first wireless device to transmit to and/or for a second wireless device. Transmitting on allocated resources and/or utilizing allocated resources may comprise transmitting data on the resources allocated, e.g., on the frequency and/or subcarrier and/or carrier and/or timeslots or subframes indicated. It may generally be considered that allocated resources may be released and/or de- allocated. A network or a node of a network, e.g., an allocation or network node, may be adapted to determine and/or transmit corresponding allocation data indicating release or de-allocation of resources to one or more wireless devices, in particular to a first wireless device.

Allocation or scheduling data may be considered to be data scheduling and/or indicating and/or granting resources allocated by the controlling or allocation node, in particular data identifying or indicating which resources are reserved or allocated for communication for a wireless device or terminal and/or which resources a wireless device or terminal may use for communication and/or data indicating a resource grant or release, in particular pertaining to uplink and/or downlink resources. A grant or resource or scheduling grant or scheduling data (which, in particular, may pertain to information regarding and/or representing and/or indicating scheduling of resources) may be considered to be one example of allocation data. Allocation data may in particular comprise information and/or instruction regarding a configuration and/or for configuring a terminal, e.g., indicating a measurement configuration to be used and/or pertaining to modulation and/or encoding and/or to other transmission and/or reception parameters. It may be considered that an allocation node or network node is adapted to transmit allocation data directly to a node or wireless device and/or indirectly, e.g., via a relay node and/or another node or base station.

Allocation data may comprise control data and/or be part of or form a message, in particular according to a pre-defined format, for example a DCI format, which may be defined in a standard, e.g., LTE. Allocation data may comprise configuration data, which may comprise instruction to configure and/or set a user equipment for a specific operation mode, in particular a measurement mode, e.g., in regards to the use of receiver and/or transmitter and/or transceiver and/or use of transmission (e.g., TM) and/or reception mode, and/or may comprise scheduling data, e.g., granting resources and/or indicating resources to be used for transmission and/or reception. A scheduling assignment may be considered to represent scheduling data and/or be seen as an example of allocation data. A scheduling assignment may in particular refer to and/or indicate resources to be used for communication or operation.

A wireless device may generally be a terminal, e.g., a user equipment.

A channel may generally be a physical channel, in particular a control channel, e.g., PUCCH. A control channel may be used for and/or carry control information, an uplink control channel for example uplink control information.

Data and/or information may generally be transmitted and/or received as signal/s, which may be carried on a time-frequency resource and/or carrier and/or subcarrier.

A cellular network or mobile or wireless communication network may comprise e.g., an LTE network (FDD or TDD), UTRA network, CDMA network, WiMAX, GSM network, any network employing any one or more radio access technologies (RATs) for cellular operation. The description herein is given for LTE, but it is not limited to the LTE RAT.

RAT (radio access technology) may generally include: e.g., LTE FDD, LTE TDD, GSM, CDMA, WCDMA, WiFi, WLAN, WiMAX, etc.

Each or any one of the radio nodes or user equipments shown in the figures may be adapted to perform the methods to be carried out by a radio node or user equipment described herein. Alternatively or additionally, each or any of the radio nodes or user equipments shown in the figures may comprise any one or any combination of the features of a user equipment described herein.

A cell may be generally a communication cell, e.g., of a cellular or mobile communication network, provided by a node. A serving cell may be a cell on or via which a network node (the node providing or associated to the cell, e.g., base station or eNodeB) transmits and/or may transmit data (which may be data other than broadcast data) to a user equipment, in particular control and/or user or payload data, and/or via or on which a user equipment transmits and/or may transmit data to the node; a serving cell may be a cell for or on which the user equipment is configured and/or to which it is synchronized and/or has performed an access procedure, e.g., a random access procedure, and/or in relation to which it is in a RRC_connected or RRC_idle state, e.g., in case the node and/or user equipment and/or network follow the LTE-standard. One or more carriers (e.g., uplink and/or downlink carrier/s and/or a carrier for both uplink and downlink) may be associated to a cell.

Data may refer to any kind of data, in particular any one of and/or any combination of control data or user data or payload data. Control data may refer to data controlling and/or scheduling and/or pertaining to the process of data transmission and/or the network or terminal operation.

In this description, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) mobile or wireless communications technologies; however, this does not rule out the use of the present concepts and aspects in connection with additional or alternative mobile communication technologies such as the Global System for Mobile Communications (GSM). While the following variants will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g., a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively or additionally, a cell may comprise at least one carrier for UL communication/transmission and DL communication/transmission, e.g., in TDD-based approaches.

A channel may generally be a logical or physical channel. A channel may comprise and/or be arranged on one or more carriers, in particular a plurality of subcarriers.

A wireless communication network may comprise at least one network node, in particular a network node as described herein. A terminal connected or communicating with a network may be considered to be connected or communicating with at least one network node, in particular any one of the network nodes described herein.

A carrier on which a LBT procedure and/or CCA and/or monitoring is performed may be an unlicensed carrier.

A transport format may be defined for and/or per transport block and/or transmission time interval (TTI). A transport format may in particular define and/or comprise indications of modulation and/or coding to be used for transmitting of signals/data.

Link adaptation (also called adaptive coding and modulation) may generally refer to adapting and/or changing transport format and/or transmission mode, in particular modulation and/or coding, to operation conditions, e.g., interference and/or pathloss and/or receiver sensitivity). Such conditions may be measured, e.g., by a UE or network node, and/or estimated and/or determined, e.g., by a network node. A UE may be adapted to perform such measurements and/or to report (transmit) corresponding information to the network/network node, which may determine and/or be adapted to determine link adaptation based on such measurements.

Some useful abbreviations comprise

MIMO Multiple input multiple output

Tx Transmitter

UE User Equipment

TTI Transmit Time Interval

BS Base Station

eNB Evolved Node B, base station

HARQ Hybrid Automatic Repeat ReQuest

E-UTRA/N Evolved universal terrestrial radio access/network

E-UTRA FDD E-UTRA frequency division duplex

E-UTRA TDD E-UTRA time division duplex

LTE Long term evolution

RAT Radio Access Technology

TDD Time division duplex

WLAN Wireless Local Area Network

SINR Signal-to-Interference Ratio

DPD Digital Predistortion

IM Inter modulation

CCA Clear Channel Assessment

CW Contention Window

DCF Distributed Coordination Function

DIFS DCF Inter-frame Spacing

DL Downlink

DRS Discovery Reference Signal

eNB evolved NodeB, base station

TTI Transmission-Time Interval

LAA Licensed Assisted Access

LBT Listen Before Talk

MRBC Multiple Random Backoff Channels/Carriers

PDCCH Physical Downlink Control Channel

PUCCH Physical Uplink Control Channel

PIFS PCF Inter-frame Spacing

PUSCH Physical Uplink Shared Channel

QCI QoS Class Identifier

QoS Quality of Service

SCell Secondary Cell

SRBC Single Random Backoff Channel/Carrier

SIFS Short Inter-frame Spacing

UE User Equipment

UL Uplink

TDD Time Division Duplexing

UL Uplink; generally referring to transmission of data to a node/into a direction closer to a network core (physically and/or logically); in particular from a D2D device or UE to a base station or eNodeB; in the context of D2D, it may refer to the spectrum/bandwidth utilized for transmitting in D2D, which may be the same used for UL communication to a eNB in cellular communication; in some D2D variants, transmission by all devices involved in D2D communication may in some variants generally be in UL spectrum/bandwidth/carrier/frequency

TPC Transmit Power Control

RE Resource Element

RB Resource Block

RAT Radio Access Technology

DL Downlink; generally referring to transmission of data to a node/into a direction further away from network core (physically and/or logically); in particular from a base station or eNodeB to a D2D device or UE; often uses specified spectrum/bandwidth different from UL (e.g., LTE)

eNB evolved NodeB; a form of base station, also called eNodeB

E-UTRA/N Evolved UMTS Terrestrial Radio Access/Network, an example of a

RAT

QAM Quadrature Amplitude Modulation, a modulation type

N-QAM N indicates a number, which may describe the order of the modulation and/or the number of possible constellation points for the modulation

OFDM Orthogonal Frequency Division Multiplexing

RRC Radio Resource Control, a format/layer of control used in LTE, in particular for an eNodeB to control a UE

AP Access point

1. A method for operating a radio node in a wireless communication network, the method comprising determining a power backoff indication based on a modulation, the method further comprising configuring a user equipment and/or a radio node with the power backoff indication, and/or transmitting signals and/or data utilizing the modulation and the power backoff indicated by the power backoff indication.

2. A radio node for a wireless communication network, the radio node being adapted for determining a power backoff indication based on a modulation, the radio node further being adapted for configuring a user equipment and/or a radio node with the power backoff indication and/or being adapted for transmitting signals and/or data utilizing the modulation and the power backoff indicated by the power backoff indication.

3. A method for operating a radio node in a wireless communication network, the method comprising determining channel state information based on a power backoff indication configured to the radio node.

4. A radio node for a wireless communication network, the radio node being adapted for determining channel state information based on a power hackoff indication configured to the radio node.

5. A program product comprising code executable by control circuitry, the code causing the control circuitry to carry out and/or control a method according to claim 1.

6. A carrier medium arrangement carrying and/or storing code executable by control circuitry, the code causing the control circuitry to perform and/or control a method according to claim 1.
